(19) United States
(12) Patent Application Publication
(10) Pub. No.: US 2026/0313593 A1
(43) Pub. Date: Oct. 8, 2026

(54) SIDELINK POSITIONING OPERATIONS BASED ON WTRU ACTING AS A POSITIONING SERVER

(71) Applicant: InterDigital Patent Holdings, Inc., Wilmington, DE (US)

(72) Inventors: Taimoor Abbas, Sainte-Julie (CA); Jung Je Son, Warrington, PA (US); Anuj Sethi, Ottawa (CA); Zhibi Wang, Woodridge, IL (US); Alec Brusilovsky, Downingtown, PA (US)

(73) Assignee: InterDigital Patent Holdings, Inc., Wilmington, DE (US)

(21) Appl. No.: 19/483,450

(22) PCT Filed: May 10, 2024
(86) PCT No.: PCT/US2024/028821

§ 371 Date: Nov. 11, 2025

Related U.S. Application Data
(60) Provisional application No. 63/465,701, filed on May 11, 2023.

(51) Int. Cl. H04W 64/00; H04W 92/18

(52) U.S. Cl. CPC H04W 64/00; H04W 92/18

(57) ABSTRACT

Systems and methods are described herein for sidelink positioning operations based on interaction between a location management function (LMF) and a sidelink positioning service wireless transmit/receive unit (WTRU). Sidelink (SL) positioning operations may be performed based on an interaction between a network entity and a SL positioning server WTRU. The WTRU may receive configuration information associated with SL positioning assistance. The WTRU may send a positioning service message to a network entity. The WTRU may determine an SL positioning service request associated with a target WTRU. The WTRU may determine positioning service information. The positioning service may be associated with the target WTRU. The WTRU may receive a message from the network entity, where the message may include a candidate list of SL reference WTRUs (e.g., first candidate list of SL reference WTRUs). The determined SL reference WTRU may be from the candidate list of SL reference WTRUs.

### CROSS-REFERENCE TO RELATED APPLICATIONS

This application claims the benefit of Provisional U.S. Patent Application No. 63/465,701, filed May 11, 2023, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems and methods are described herein for sidelink positioning operations based on interaction between a location management function (LMF) and a sidelink positioning service wireless transmit/receive unit (WTRU).

Sidelink (SL) positioning operations may be performed based on an interaction between a network entity (e.g., location management function) and a SL positioning server WTRU. A WTRU may include a sidelink (SL) positioning server WTRU. The WTRU may be associated with one or more of a location or a service area. The WTRU may receive configuration information associated with SL positioning assistance. The WTRU may send a positioning service message to a network entity. The capability information may indicate that the WTRU is capable of acting as an SL positioning server WTRU. The WTRU may determine an SL positioning service request associated with a target WTRU. The SL positioning service request may indicate one or more of a WTRU ID, reference WTRU information, or positioning requirement information. The SL positioning service request may indicate a first WTRU and a second WTRU (e.g., first target WTRU and a second target WTRU). The WTRU may determine positioning service information associated with a positioning service. The positioning service may be associated with the target WTRU. The positioning service information may include a positioning method and/or an SL reference WTRU. The positioning service information may be determined based on one or more of the configuration information associated with SL positioning assistance and/or a received indication from the network entity. The WTRU may receive a message from the network entity, where the message may include a candidate list of SL reference WTRUs (e.g., first candidate list of SL reference WTRUs). The determined SL reference WTRU may be from the candidate list of SL reference WTRUs. The WTRU may be collocated with the target WTRU or SL reference WTRU. The WTRU may send an SL positioning response to the target WTRU. The SL positioning response may indicate the determined positioning service information.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example reference model of a network for Location Service.

FIG. 3 illustrates an example procedure of SL positioning operation with one or more interactions between LMF and SL positioning server WTRU.

### DETAILED DESCRIPTION

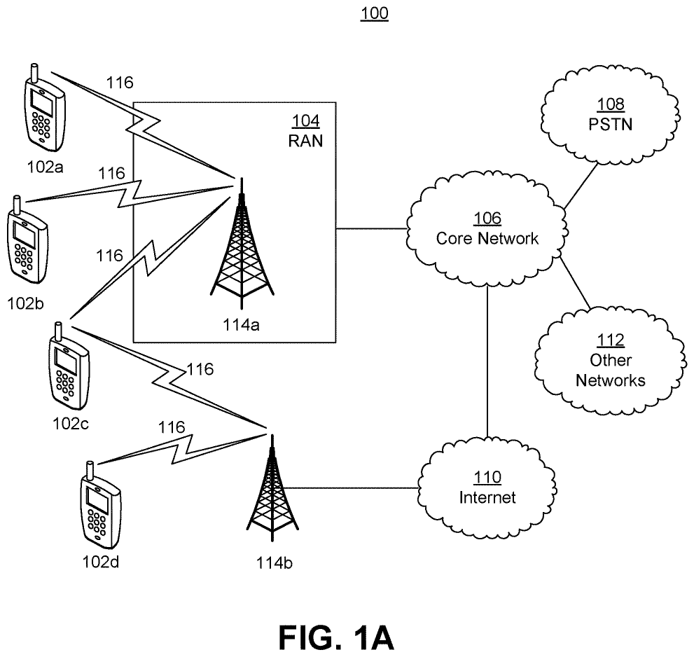

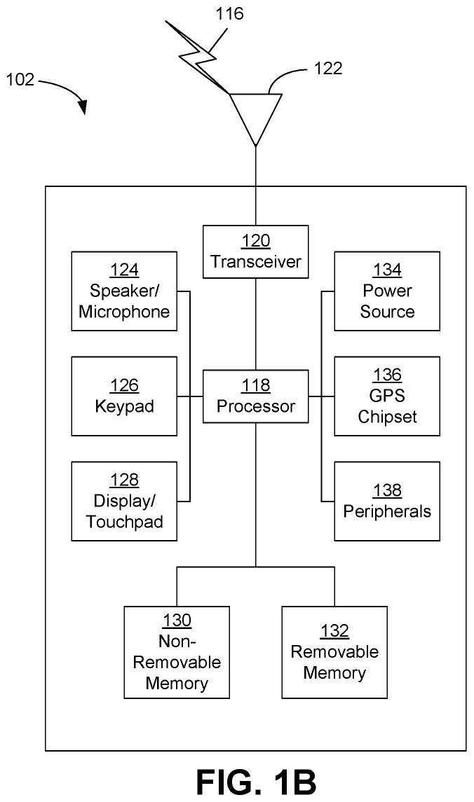

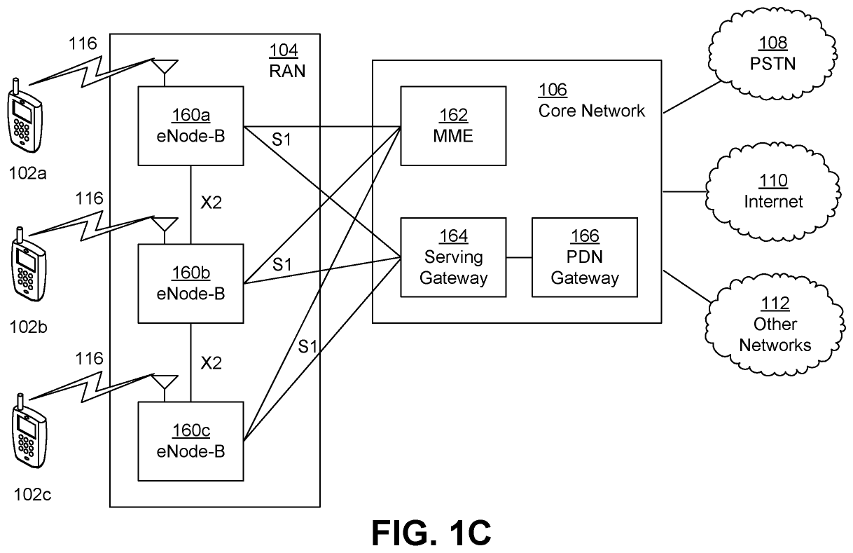

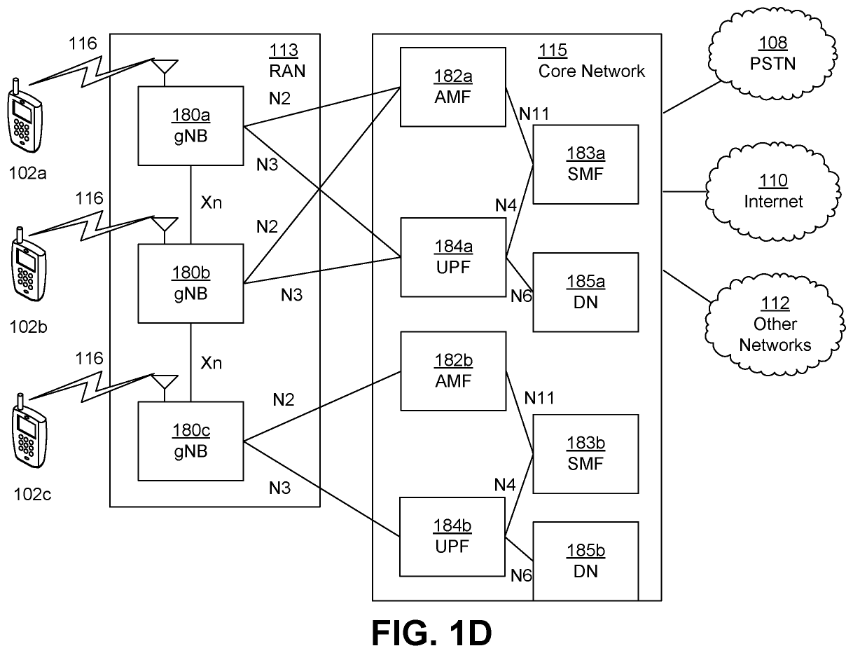

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102 c, 102 d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, one or more emulation devices may perform one or more, or all, functions while being fully or partially implemented and/or deployed as part of a wired and/or wireless communication network to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods are described herein for sidelink positioning operations based on interaction between a location management function (LMF) and a sidelink positioning service wireless transmit/receive unit (WTRU).

Sidelink (SL) positioning operations may be performed based on an interaction between a network entity (e.g., location management function) and a SL positioning server WTRU. A WTRU may include a sidelink (SL) positioning server WTRU. The WTRU may be associated with one or more of a location or a service area. The WTRU may receive configuration information associated with SL positioning assistance. The WTRU may send a positioning service message to a network entity. The capability information may indicate that the WTRU is capable of acting as an SL positioning server WTRU. The WTRU may determine an SL positioning service request associated with a target WTRU. The SL positioning service request may indicate one or more of a WTRU ID, reference WTRU information, or positioning requirement information. The SL positioning service request may indicate a first WTRU and a second WTRU (e.g., first target WTRU and a second target WTRU). The WTRU may determine positioning service information associated with a positioning service. The positioning service may be associated with the target WTRU. The positioning service information may include a positioning method and/or an SL reference WTRU. The positioning service information may be determined based on one or more of the configuration information associated with SL positioning assistance and/or a received indication from the network entity. The WTRU may receive a message from the network entity, where the message may include a candidate list of SL reference WTRUs (e.g., first candidate list of SL reference WTRUs). The determined SL reference WTRU may be from the candidate list of SL reference WTRUs. The WTRU may be collocated with the target WTRU or SL reference WTRU. The WTRU may send an SL positioning response to the target WTRU. The SL positioning response may indicate the determined positioning service information.

A WTRU (e.g., sidelink (SL) positioning server WTRU) may (e.g., be configured to) perform one or more of the following: receive configuration information from a network function (NF) such as a policy control function (PCF) (e.g., for the SL positioning server WTRU to assist with the SL positioning service); send a positioning service message (e.g., to the LMF) which may indicate the capability to act as a positioning server WTRU (e.g., which may include one or all actions supported as a positioning server WTRU); receive (e.g., from the LMF) a list of located SL reference WTRUs available, for example, based on server WTRU's location or serving area; receive (e.g., from the LMF) a general resource pool per area or per server WTRU, e.g., if multiple server WTRUs are located in the same area (e.g., where the definition of the area may be up to an LMF to decide); receive over PC5 link (e.g., from a target and/or a reference WTRU) a message, e.g., a SL positioning service request message that may include target WTRU ID, SL reference WTRU ID(s), capability of WTRUs, NAS/no NAS connection per WTRU, and/or positioning requirements; determine (e.g., based on the received input) a positioning method and/or a SL reference WTRU; interact with the LMF (e.g., back and forth messaging), for example, to determine a positioning method and/or a SL reference WTRU for a given positioning service request; receive dedicated radio resource(s) from the LMF for the requested positioning service (e.g., where these resource may be used for PC5 communication between a target WTRU and an SL reference WTRU as well as between an SL reference WTRU and an SL positioning WTRU); send over a PC5 link (e.g., to the target WTRU and/or SL reference WTRU) a message that includes a selected positioning method, a selected SL reference WTRU, a respective target WTRU (e.g., if the message may be sent to reference WTRU), and assigned radio resources; and/or the like.

Sidelink (SL) positioning operation(s) may be performed and/or provided. SL positioning operation(s) may include one or more interactions between a location management function (LMF) and server WTRU.

A SL positioning server WTRU may (e.g., be configured to) perform one or more of the following: receive configuration information from a network function (NF) such as a policy control function (PCF) (e.g., for the SL positioning server WTRU to assist with the SL positioning service); send a positioning service message to the LMF which may indicate the capability to act as a positioning server WTRU (e.g., which may include action(s) supported as a positioning server WTRU); receive from the LMF, for example, a list of located SL reference WTRUs available based on server WTRU's location or serving area; receives from the LMF a general resource pool per area or per server WTRU, e.g., if multiple server WTRUs are located in the same area (e.g., where the definition of the area may be up to an LMF to decide); receive over a PC5 link (e.g., from a target and/or a reference WTRU) a message, e.g., a SL positioning service request message that may include target WTRU ID, SL reference WTRU ID(s), capability of WTRUs, NAS/no NAS connection per WTRU, and/or positioning requirements; determine (e.g., based on the received input) a positioning method and/or a SL reference WTRU; interact with the LMF (e.g., back and forth messaging), for example, to determine a positioning method and/or a SL reference WTRU for a given positioning service request; receive dedicated radio resource(s) from the LMF for the requested positioning service (e.g., where these resource may be used for PC5 communication between a target WTRU and an SL reference WTRU as well as between an SL reference WTRU and an SL positioning WTRU); send over a PC5 link (e.g., to the target WTRU and/or SL reference WTRU) a message that includes a selected positioning method, a selected SL reference WTRU, and a respective target WTRU (e.g., if the message may be sent to reference WTRU), and assigned radio resources; and/or the like.

A target WTRU may (e.g., be configured to) perform one or more of the following: send a sidelink positioning request message to an SL positioning server WTRU, which may include one or more located SL reference WTRU ID(s), their status and capabilities, and/or positioning service requirements; receive a message from the server WTRU that may include selected positioning method, select an SL reference WTRU, and/or assigned radio resources; and/or the like.

An SL reference WTRU may (e.g., be configured to) perform one or more of the following: send a sidelink positioning request message to a SL positioning server WTRU, which may include one or more located target WTRU ID(s), their status and capabilities, and/or positioning service requirements (e.g., if available, e.g., shared by the target WTRU with the SL reference WTRU); receive a message from server WTRU (e.g., if selected as SL reference WTRU) that may include selected positioning method, respective target WTRU, and/or assigned radio resources; and/or the like.

An LMF may (e.g., be configured to) perform one or more of the following: request the PCF to send any policy updates to the LMF, for example, based on the SL positioning server WTRU ID; send (e.g., to the positioning server WTRU) a general resource pool per area or per WTRU, for example, if multiple WTRUs are located in a given area; send to the positioning server WTRU dedicated resource for a request positioning service for PC5 communication between target, SL reference, and server WTRU; and/or the like.

Location Service(s) (LCS) may be performed and/or provided.

Location service(s) (e.g., 5G location service) may provide functionality to provide positioning information of a WTRU.

The positioning of a WTRU can be supported, for example, by a RAT dependent position method, which may use (e.g., rely on) RAT measurements obtained by a target WTRU and/or on measurements obtained by an Access Network of RAT signals transmitted by a target WTRU. Positioning of a WTRU may be supported by RAT independent position methods which may use (e.g., rely on) non-RAT measurements obtained by a WTRU and/or use other information.

Location information for one or multiple target WTRUs may be requested by and reported to an LCS client or an AF within or external to an operator network or a control plane NF within the system (e.g., wireless system, such as a WTRU).

Privacy (e.g., settings) verification of the target WTRU may (e.g., shall) be enabled to check whether it may (e.g., is allowed) to acquire the WTRU location information, for example, for location requests from an LCS client or an AF.

Different types of location requests may be supported, such as, for example, one or more of the following: mobile terminated location request (MT-LR); mobile originated location request (MO-LR); immediate location request; deferred location request; and/or the like.

A Mobile Terminated Location Request (MT-LR) may include an LCS client or AF sending a location request to the network for the location of a target WTRU.

A Mobile Originated Location Request (MO-LR) may include a WTRU sending a request to the network for location related information for the WTRU.

A location request (e.g., immediate location request) may include (e.g., an LCS client or AF) sending or instigating a location request for a target WTRU(s), for example, where the LCS client or AF may (e.g., expect to) receive a response containing location information for the target WTRU(s) within a time period (e.g., short time period). The location request (e.g., which may be an immediate location request) may be used for an MT-LR or MO-LR.

A deferred location request may include (e.g., an LCS client or AF) sending a location request to the network for a target WTRU(s), for example, wherein the LCS client or AF may expect to receive a response if (e.g., when) an indicated event occurs for the target WTRU (e.g., at some future time). The deferred location request may be used for an MT-LR.

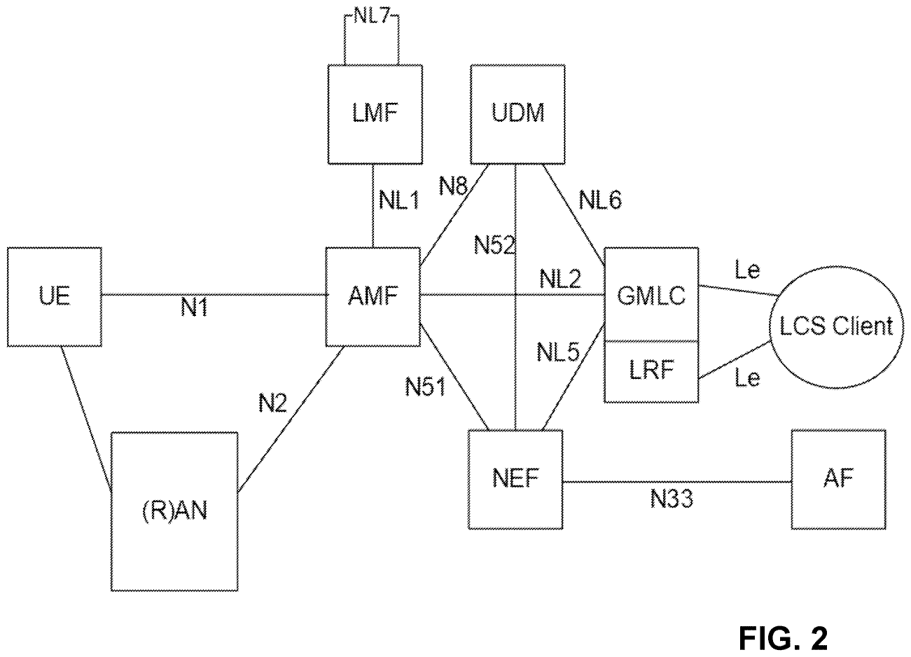

FIG. 2 illustrates an example reference model of a network for Location Service. (R)AN here may refer to (e.g., represent) NG-RAN, trusted (e.g., non-3GPP) access, or untrusted (e.g., non-3GPP) access. The access network may be involved in the handling of various positioning procedures, for example, such as positioning of a target WTRU, provisioning of location related information not associated with a particular target WTRU, and/or transfer of positioning messages between an AMF or LMF and a target WTRU.

AFs and NFs may access LCS services, for example, from a GMLC in the same operator network.

LCS clients may access LCS services from a GMLC. An External AF may access LCS services from a NEF.

A Gateway Mobile Location Centre (GMLC) may handle the request from the external LCS client, AF, for example, via NEF (e.g., if AF is external AF and forwards the location request to the proper NF).

Location Retrieval Function (LRF) may retrieve or validate (e.g., be responsible for retrieving or validating) location information and may be collocated with a GMLC or standalone.

The LMF may manage the (e.g., overall) coordination and scheduling of resources used (e.g., required) for the location of a WTRU that is registered with or accessing the core network (e.g., 5GCN). It may calculate or verify final location related information and achieved accuracy.

SL positioning (e.g., Sidelink based positioning) service may be enabled, used, and/or provided.

SL positioning may refer to a positioning WTRU (e.g., using PC5) to obtain an absolute position, relative position, or ranging information. Ranging may refer to a determination of the distance between two WTRUs or more WTRUs and/or the direction of one WTRU (e.g., Target WTRU) from another WTRU (e.g., Reference WTRU) via the PC5 interface.

For SL positioning, target WTRU, SL Reference WTRU, SL positioning client WTRU, and/or located WTRU may be defined (e.g., but are not limited to) and used as follows. A Target WTRU may include a WTRU whose distance, direction, and/or position may be measured with the support from one or multiple SL Reference WTRUs using Sidelink in the Ranging based service and Sidelink positioning. A Located WTRU may include an SL Reference WTRU of which the location may be known or may be known (e.g., using Uu based positioning). A Located WTRU may be used to determine the location of a Target WTRU, for example, using Sidelink Positioning. An SL Reference WTRU may include a WTRU supporting positioning of the target WTRU (e.g., by transmitting and/or receiving reference signals for positioning) providing positioning-related information, etc. using sidelink. A SL Positioning Client WTRU may include a third-party WTRU (e.g., other than a SL Reference WTRU or Target WTRU), which may initiate a Ranging/Sidelink positioning service request on behalf of the application residing on it.

The operation of Ranging/Sidelink Positioning may be performed either as Network-assisted Operation or WTRU-only Operation. For example, in the Network-assisted Operation, core network NF(s) (e.g., 5GC NF(s) may be involved in the service request handling and result calculation. For example, in the WTRU-only Operation, the service request handling and result calculation operations may be performed by the WTRU.

An LMF (e.g., as defined in the Location Service) may be used to support triggering SL positioning, coordination of SL positioning operation, and/or delivering the result to the client, for example, if (e.g., when) Network-assisted operation is used. The Ranging/Sidelink Positioning service request can be initiated by a WTRU (e.g., SL Positioning Client WTRU, Target WTRU, SL Reference WTRU), a core network NF (e.g., 5GC NF), an LCS Client, and/or an AF.

WTRUs may interact with each other (e.g., over PC5) as necessary, for example, to perform SL positioning operations if (e.g., when) an WTRU (e.g., an WTRU-only) operation is used. The SL positioning server WTRU may be defined to coordinate the SL positioning operation and calculate the positioning result.

An SL Positioning Server WTRU may include a WTRU offering method determination, assistant data distribution, and/or location calculation functionalities and/or location calculation functionalities for Sidelink Positioning and Ranging based service.

NW Assisted SL positioning may be enabled, performed, and/or provided.

NW Assisted SL positioning may be used to estimate the location of a WTRU with the assistance of the network by using the location of one or more Located WTRUs and the distance and/or direction between the WTRU and the Located WTRU(s).

The Network assisted SL Positioning feature may include one or more of the following cases: if (e.g., when) the WTRU can establish a NAS signaling connection; if (e.g., when) the WTRU refrains from establishing (e.g., cannot establish) a NAS signaling connection; etc.

The WTRU may enter a CM-Connected state by performing WTRU triggered Service Request for MO-LR (e.g., 5GC-MO-LR) or performing Network triggered Service Request for NI-LR (e.g., 5GC-NI-LR) or MT-LR (e.g., 5GC-MT-LR), for example, if (e.g., when) a WTRU can establish a NAS connection. The functionality specified in the Location Service may be reused (e.g., including MO-LR, MT-LR, and NI-LR), for example, as the Target WTRU may establish a NAS signaling connection with the AMF.

The Target WTRU or the LMF may determine if network assisted SL positioning may be applied.

The Target WTRU may discover Located WTRU(s) for network assisted SL positioning.

The Target WTRU and Located WTRU(s) may perform ranging/SL positioning. The Target WTRU may include the WTRU identity of the Located WTRU(s) to the LMF together with the Ranging measurement data or estimation result. The LMF may interact with GMLC to get the location of Located WTRU.

The LMF may use the location of Located WTRU(s) together with the ranging/SL positioning measurement data or estimation results reported by Target WTRU and/or (e.g., optionally) by Located WTRUs to estimate the location of the Target WTRU.

If (e.g., when) the Target WTRU refrains from establishing (e.g., cannot establish) the NAS connection with AMF due to the Target WTRU being out of coverage or other reasons (e.g., invalid subscription, rejection by NW), one or more of the following may apply: the Target WTRU may perform the Located WTRU's discovery and selection; the Target WTRU may transmit its ranging measurements/results to the Located WTRU(s); the Located WTRU(s) may report the ranging/SL positioning measurement result to the LMF (e.g., which may include ranging measurements/results received from the Target WTRU, and the endpoints for LPP messages may be the LMF and the Located WTRU(s)); the LMF may use the received information to calculate the location of the Target WTRU and may provide the resulting location via the Located WTRU to the Target WTRU or via the NF to the LCS client or the Application Server.

SL positioning service exposure to the WTRU may be enabled and/or provided.

A WTRU (e.g., SL positioning client WTRU) may request SL positioning through PC5 or NW.

The SL positioning client WTRU can discover one of the Reference WTRU and Target WTRU, and it may invoke the Ranging/SL Positioning service request to the discovered Reference WTRU/Target WTRU for obtaining the Ranging and SL positioning result between Reference WTRU and Target WTRU, for example, if (e.g., when) the SL positioning client UE requests SL positioning service through PC5 connection. The request may include the user information of the SL Positioning Client WTRU, Reference WTRU, and/or Target WTRU.

SL positioning service operation(s) with LMF or SL positioning server WTRU may be performed, for example, based on (e.g., after) receiving an SL positioning service request.

An SL positioning server WTRU may coordinate with an LMF (e.g., for SL positioning service), for example, to better assist SL positioning between the target WTRU and SL reference WTRU.

An SL Positioning Server WTRU can be discovered and may be selected for result calculation, method determination, assistant data distribution, and/or SL Reference UE selection, for example, for out-of-coverage or for WTRU-only Operation (e.g., if the serving network does not support Ranging/SL Positioning). The LMF may decide that an SL Positioning Server WTRU (e.g., co-located/integrated with a Target WTRU or Reference WTRU) may execute the result calculation, for example, if the LMF capable of Ranging/SL Positioning is reachable by Target WTRU and/or Reference WTRU. An SL Positioning Server WTRU can be co-located with a Target WTRU or Reference WTRU.

The LMF may be aware of available SL positioning server WTRUs within its service area (e.g., it may be assumed (e.g., based on the above) that the LMF may be aware of available SL positioning server WTRUs within its service area). There may be one or more SL positioning server WTRUs per service area. The coordination between the LMF and SL positioning server WTRU may not be clear.

The service quality of the SL positioning service operation may not be as good as the one provided by the LMF (e.g., because the resources used by WTRUs based on the coordination of SL positioning server may be shared among many WTRUs performing SL positioning operation and configuration for SL positioning operation may be based on the preconfigured parameters having more probability to have a conflict with other similar operations), for example, if (e.g., when) an SL positioning server WTRU is involved in the coordination of the SL positioning operation. It may avoid such conflicts.

An SL positioning server WTRU may assist (e.g., better assist) SL positioning between the target WTRU and SL reference WTRU, for example, if the LMF is aware of the SL positioning server WTRU.

An SL positioning server WTRU may assist the SL positioning client WTRU to select an SL reference WTRU for the SL positioning service.

The LMF may decide that an SL Positioning Server WTRU (e.g., co-located/integrated with a Target WTRU or Reference WTRU) may execute the result calculation, for example, (e.g., as described herein) if the LMF capable of Ranging/SL Positioning is reachable by Target WTRU and/or Reference WTRU. It may not be clear if (e.g., when) LMF moves the positioning service operation to server WTRU.

The SL positioning server WTRU may have a better knowledge about available SL reference WTRUs nearby, for example, as it may perform coordination between peer WTRUs (e.g., SL reference WTRUs and/or between SL client WTRUs and SL reference WTRUs). This information may be used to assist in the positioning service operation that may be provided by the server WTRU.

The SL positioning server WTRU may interact with LMF, for example, to receive available assistance data at the LMF (e.g., that can be used to improve positioning service in the service area of the positioning server).

The SL positioning server WTRU may assist the SL positioning client WTRU in selecting an SL reference WTRU for the SL positioning service.

A WTRU may be one or more of the following: client WTRU, SL client WTRU, reference WTRU, SL reference WTRU, SL positioning reference WTRU, server WTRU, positioning server WTRU, SL server WTRU, SL positioning server WTRU, etc.

The terms SL client WTRU and client WTRU (e.g., as described herein) may be used interchangeably.

The terms SL positioning reference WTRU, SL reference WTRU, and reference WTRU (e.g., as described herein) may be used interchangeably.

The terms SL positioning server WTRU, SL server WTRU, positioning server WTRU, and server WTRU (e.g., as described herein) may be used interchangeably.

The WTRU may (e.g., be assumed to) support PC5 Signaling. This PC5 signaling may be supported by the ProSe layer in the WTRUS.

The WTRU(s) (e.g., as described herein) may have the capability of ranging and sidelink positioning and/or the capability of sideline positioning server WTRU. Sidelink positioning may refer to the positioning via the PC5 interface, and ranging may refer to a determination of the distance between two or more WTRUs and/or the direction and/or relative positioning of one WTRU to another WTRU.

SL positioning operation with one or more interactions between the LMF and SL positioning server WTRU may be performed, enabled, and/or provided.

A WTRU, such as a positioning server WTRU, may (e.g., if/when registering to the network) receive policy configuration information from an NF (e.g., such as PCF, for example, that may be specific for an SL positioning server WTRU based on its capability and subscription information). SL positioning server may inform the LMF about its capability as server WTRU and may share (e.g., some or all of) the policy configuration information it received. The LMF may request (e.g., also request) PCF, for example, if there is an update in the policy linked with the SL positioning server WTRU.

The LMF (e.g., based on the received input from the SL positioning server WTRU, its service area, and/or location) may send a list of located SL reference WTRUs in that area. The LMF may send a resource pool (e.g., general resource pool) per server WTRU or per service area, and/or (e.g., any) assistance data that may be useful for a server WTRU in positioning service operations.

The positioning server WTRU may use this input (e.g., from the LMF) to assist the target WTRUS, for example, based on (e.g., upon) reception of a positioning service request from one of the target or SL reference WTRUs. The SL positioning server may receive further information as part of the SL positioning service request, which may help the server WTRU in the determination of a positioning method and selection of SL reference WTRU(s). The positioning server WTRU may coordinate with the LMF in the determination process (e.g., if required).

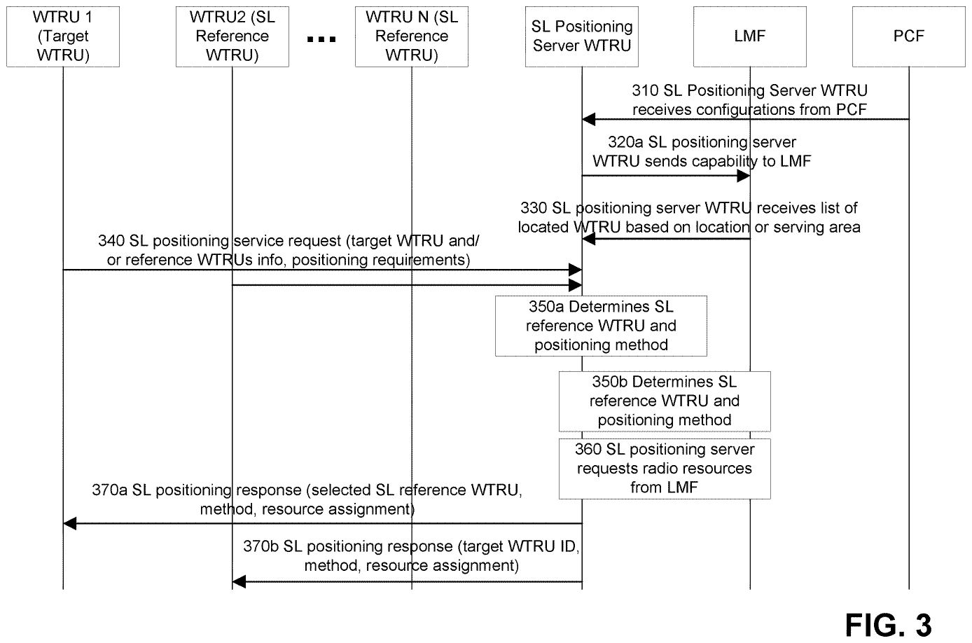

FIG. 3 illustrates an example procedure of SL positioning operation with one or more interactions between LMF and SL positioning server WTRU.

As shown at 310 in FIG. 3, the SL positioning server WTRU (e.g., which may also be a target WTRU or a SL reference WTRU) may receive configuration information from the NF (e.g., such as PCF for SL positioning server WTRU), for example, to assist with the SL positioning service (e.g., the configuration information may be associated with SL positioning assistance). The configuration information may be provided by the AF for Ranging/Positioning (e.g., as well).

In examples, an authentication and authorization (e.g., mutual authentication and authorization) may (e.g., should) be performed. Authorization evidence (e.g., such as an authorization token) may (e.g., should) be issued to the SL positioning server WTRU (e.g., by the network).

As shown at 320 in FIG. 3, the SL positioning server WTRU may send a positioning service message to a network entity, such as the LMF, (e.g., indicating capability information, for example, indicating the capability to act as a positioning server WTRU), for example, which may include the capability to perform (e.g., some or all) actions supported as a positioning server WTRU (e.g., result calculation, method determination, assistant data distribution, and/or SL Reference WTRU selection).

As shown at 330 in FIG. 3, the SL positioning server WTRU may receive (e.g., from the network entity/LMF) a list of located SL reference WTRUs (e.g., candidate list of SL reference WTRUs) that may be available, for example, based on the server WTRU's location or serving area. It may share a list of other SL server WTRUs in proximity along with their supported capabilities. The definition of the area may be determined by an LMF, for example, which may be a broad area such as TA, a service area of the LMF, or a more focused area within direct proximity of the server WTRU.

As shown at 340 in FIG. 3, the SL positioning server WTRU may be assigned by LMF a general/generic resource pool per area for SL positioning operation or a different resource pool per SL positioning server WTRU, for example, if there are multiple WTRUs sharing the same area.

The Target WTRU or the SL reference WTRU may initiate the SL positioning request (e.g., SL positioning request associated with the target WTRU; SL positioning request that indicates a first WTRU and/or a second WTRU), for example, which may include information of at least one or a list of SL reference WTRU(s) discovered by the WTRU (e.g., WTRU IDs, status information (e.g., NAS/no NAS), capability), target WTRU information, and/or positioning information (e.g., requirements). The SL positioning service request may be determined, for example, by the SL positioning server WTRU (e.g., which may be co-located with the target WTRU or SL reference WTRU or may be the target WTRU or the SL reference WTRU).

Positioning service information (e.g., positioning method and/or SL reference WTRU(s) may be determined (e.g., selected), as shown at 350a and 350b in FIG. 3.

As shown at 350a in FIG. 3, the SL positioning server WTRU may determine (e.g., itself) positioning service information (e.g., positioning method and/or SL reference WTRU(s), for example, based on the received configuration information from the NFs (e.g., PCF, LMF) or AF, and input from the WTRUs for Ranging/Positioning. The SL positioning server WTRU may select one or more SL reference WTRU(s) and may select assistant data for distribution and/or its availability for result calculation.

As shown at 350b in FIG. 3, the SL positioning server WTRU may communicate with the LMF (e.g., one or more messages exchanged between server WTRU and LMF where positioning requirements may be sent to the LMF as received by server WTRU) for the selection of a SL positioning method, for example, to request additional assistance data from LMF, or better resource assignment before performing the actions in 350a.

For example, as shown at 360 in FIG. 3, (e.g., if 5a is true) the SL positioning server WTRU may request dedicated radio resources from the LMF for the requested positioning service (e.g., if highly accurate positioning is desired), and there are many WTRUs requesting positioning service from the SL positioning server WTRU, and there is a chance for message collision.

As shown at 370a and 7b in FIG. 3, the SL positioning server may send one or more of the following.

As shown at 370a in FIG. 3, the SL positioning server may send a message over PC5 link (e.g., SL positioning response message) to the target WTRU, for example, that may include the positioning information (e.g., selected positioning method and/or SL reference WTRU(s)), and may select SL reference WTRU ID(s), and assigned radio resources.

As shown at 370b in FIG. 3, the SL positioning server may send a message to the SL reference WTRU (e.g., an indication if selected as an SL reference WTRU for positioning assistance with the target WTRU) that may include the selected positioning method, respective target WTRU ID, and/or assigned radio resources.

In examples, (e.g., at 350 in FIG. 3), the SL positioning server WTRU (e.g., based on the capability and load) may pass the request to another server WTRU. In examples (e.g., alternatively), SL positioning server WTRU selection can be done by the SL positioning server itself or by the assistance from LMF. In this procedure, based on (e.g., upon) positioning service request from the SL positioning client WTRU, the server WTRU might relocate this request to another server WTRU, itself or ask the LMF to suggest another server ID, which may be capable of handling the positioning request from the client WTRU. The current server WTRU could be under circumstances where it may not handle the request from the client WTRU.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is

1. A wireless transmit/receive unit (WTRU) comprising:
a processor configured to:
receive configuration information associated with sidelink (SL) positioning assistance;
send a positioning service message to a network entity indicating capability information, wherein the capability information indicates that the WTRU is capable of acting as an SL positioning server WTRU;
determine an SL positioning service request associated with a target WTRU;
determine positioning service information associated with a positioning service, wherein the positioning service is associated with the target WTRU, and wherein the positioning service information comprises at least one of a positioning method or an SL reference WTRU;
send an SL positioning response to the target WTRU indicating the determined positioning service information.

2. The WTRU of claim 1, wherein the processor is further configured to:
receive a message from the network entity comprising a candidate list of SL reference WTRUs, wherein the SL reference WTRU is from the candidate list of SL reference WTRUs.

3. The WTRU of claim 1, wherein the SL positioning service request indicates at least one of a target WTRU ID, reference WTRU information, or positioning requirement information.

4. The WTRU of claim 1, wherein the WTRU is a sidelink positioning server WTRU.

5. The WTRU of claim 1, wherein the WTRU is the target WTRU or the SL reference WTRU.

6. The WTRU of claim 1, wherein the SL reference WTRU is associated with at least one of a location or a service area.

7. The WTRU of claim 1, wherein the determination of the positioning service information associated with a positioning service associated with the target WTRU is based on at least one of the received configuration information associated with SL positioning assistance or a received indication from the network entity.

8. The WTRU of claim 1, wherein the target WTRU is a first WTRU, and wherein the SL positioning service request indicates the first WTRU and a second WTRU.

9. A method, the method comprising:
receiving configuration information associated with sidelink (SL) positioning assistance;
sending a positioning service message to a network entity indicating capability information, wherein the capability information indicates that a wireless transmit/receive unit (WTRU) is capable of acting as an SL positioning server WTRU;
determining an SL positioning service request associated with a target WTRU;
determining positioning service information associated with a positioning service, wherein the positioning service is associated with the target WTRU, and wherein the positioning service information comprises at least one of a positioning method or an SL reference WTRU;
sending an SL positioning response to the target WTRU indicating the determined positioning service information.

10. The method of claim 9, wherein the method further comprises:
receiving a message from the network entity comprising a candidate list of SL reference WTRUS, wherein the SL reference WTRU is from the candidate list of SL reference WTRUs.

11. The method of claim 9, wherein the SL positioning service request indicates at least one of a target WTRU ID, reference WTRU information, or positioning requirement information.

12. The method of claim 9, wherein the method is performed by the WTRU, wherein the WTRU is a sidelink positioning server WTRU.

13. The method of claim 9, wherein the method is performed by the WTRU, wherein the WTRU is the target WTRU or the SL reference WTRU.

14. The method of claim 9, wherein the SL reference WTRU is associated with at least one of a location or a service area.

15. The method of claim 9, wherein the determination of the positioning service information associated with a positioning service associated with the target WTRU is based on at least one of the received configuration information associated with SL positioning assistance or a received indication from the network entity.

16. The method of claim 9, wherein the target WTRU is a first WTRU, and wherein the SL positioning service request indicates the first WTRU and a second WTRU.
